(19) United States
(12) Patent Application Publication
(10) Pub. No.: US 2025/0158483 A1
(43) Pub. Date: May 15, 2025

(54) MAGNETIC LEVITATION DEVICE AND A CENTRIFUGAL PUMP

(71) Applicant: Levitronix GmbH, Zürich (CH)

(72) Inventors: Marcel STETTLER, Zofingen (CH); Thomas SCHNEEBERGER, Bern (CH); Natale BARLETTA, Zürich (CH); Patrick HINNI, Netstal (CH)

(21) Appl. No.: 18/931,257

(22) Filed: Oct. 30, 2024

(30) Foreign Application Priority Data
Nov. 15, 2023 (EP) 23210165.9

(51) Int. Cl. H02K 7/09; F04D 29/048

(52) U.S. Cl. CPC H02K 7/09; F04D 29/048

(57) ABSTRACT

A magnetic levitation includes a stator with coil cores, a concentrated winding provided at each longitudinal leg of the coil cores surrounding a respective longitudinal leg, the stator including a cup-shaped recess into which a rotor is configured to be inserted, magnetic field sensors to determine the position of the rotor arranged around the cup-shaped recess, and a ring-shaped holding device for the magnetic field sensors, the ring-shaped holding device having a cavity for each magnetic field sensor, the cavity delimited with respect to the radial direction by an inside wall and by an outside wall. The magnetic field sensors to be pushed into the cavity, and the cavity dimensioned such that the inside wall and the outside wall rest flat against the magnetic field sensors.

### PRIORITY

This application claims priority to European Application No. 23210165.9, filed Nov. 15, 2023, the contents of which are hereby incorporated by reference.

### BACKGROUND

### Technical Field

The disclosure relates to a magnetic levitation device and to a centrifugal pump with such a magnetic levitation device.

### Background Information

Generally magnetic bearing devices for the contactless magnetic bearing of a rotor have the advantage that they do not require mechanical bearings for the rotor. The rotor is supported or stabilized by magnetic forces generated by a stator of the magnetic bearing device. Due to the absence of mechanical bearings, such magnetic bearing devices are in particular suitable for pumping, mixing, centrifuging or stirring devices, with which very sensitive substances are conveyed, for example blood pumps, or on which very high demands are made with respect to purity, for example in the pharmaceutical industry or in the biotechnological industry, or with which abrasive or aggressive substances are conveyed, which would very quickly destroy mechanical bearings, for example pumps or mixers for slurry, sulfuric acid, phosphoric acid or other chemicals in the semiconductor industry.

In the biotechnology industry, such magnetic bearing devices are used, for example, in connection with bioreactors, e.g. in centrifugal pumps for conveying the fluids into or out of the bioreactor, or in mixing devices which mix the fluids in the bioreactor. In the semiconductor industry, such magnetic bearing devices are not only used for conveying aggressive or abrasive substances, but also, for example, for rotation devices with which wafers are rotated.

It is also known to use magnetic bearing devices for viscometers.

### SUMMARY

It has been determined that an advantageous and design known per se of a magnetic bearing device is the design in temple construction, to which the present disclosure also relates.

The characteristic feature of the temple construction is that the stator of the magnetic bearing device has a plurality of coil cores, each of which comprises a longitudinal leg extending from a first end in an axial direction to a second end. Here, the axial direction refers to that direction which is defined by the desired axis of rotation of the rotor, which is supported by the magnetic bearing device. The desired axis of rotation is that axis of rotation about which the rotor rotates in the operating state when it is in a centered and non-tilted position with respect to the stator. Each coil core comprises, in addition to the longitudinal leg, a transverse leg, which is arranged in each case at the second end of the longitudinal leg, and which extends in the radial direction-usually towards inside-, wherein the radial direction is perpendicular to the axial direction. Thus, the transverse leg extends substantially at a right angle to the longitudinal leg. The coil cores each have the shape of an L, wherein the transverse legs form the short legs of the L. The rotor to be supported is then arranged between the transverse legs.

The plurality of the longitudinal legs which extend in the axial direction, and which are reminiscent of the columns of a temple has given this construction its name.

In one design, the stator of the magnetic bearing device has, for example, six coil cores which are arranged circularly and equidistantly around a cup-shaped recess into which the rotor can be inserted. The first ends of the longitudinal legs are usually connected in the circumferential direction by a back iron, which serves to conduct the magnetic flux. The rotor to be supported comprises a magnetically effective core, for example a permanent magnetic disk or a permanent magnetic ring, which is arranged between the radially inner ends of the transverse legs, and which rotates about the axial direction in the operating state, wherein the rotor is magnetically supported without contact with respect to the stator.

For such magnetic bearing devices, it is not necessarily the case that the magnetically effective core of the rotor must be designed in a permanent magnetic manner. There are also known such designs in which the magnetically effective core of the rotor is designed in a permanent magnetic-free manner, i.e., without permanent magnets. Then, the magnetically effective core of the rotor is, for example, designed in a ferromagnetic manner and is made, for example, of iron, nickel-iron, cobalt-iron, silicon iron, mu-metal, or another ferromagnetic material.

Furthermore, designs are possible in which the magnetically effective core of the rotor comprises both ferromagnetic materials and permanent magnetic materials. For example, permanent magnets can be placed or inserted into a ferromagnetic base body. Such designs are advantageous, for example, if one wishes to reduce the costs of large rotors by saving permanent magnetic material.

The longitudinal legs carry windings to generate the electromagnetic fields necessary for the contactless magnetic bearing of the rotor. For example, the windings are designed such that one concentrated winding is wound around each longitudinal leg, i.e., the coil axis of each concentrated winding extends in each case in the axial direction. Here, it is typical for the temple construction that the coil axes of the concentrated windings run in the axial direction and that the concentrated windings are not arranged in the radial plane in which the rotor or the magnetically effective core of the rotor is supported in the operating state.

Designs are possible in which exactly one concentrated winding is arranged on each longitudinal leg. In other designs, several, for example exactly two, concentrated windings are provided on each longitudinal leg. Designs are also possible in which windings are provided that are wound around two longitudinal legs that are adjacent in the circumferential direction, so that these two adjacent longitudinal legs are both located in the interior of the concentrated winding.

It is very important for a reliable and safe contactless magnetic bearing of the rotor to know the current position of the rotor in the radial plane with high accuracy in each case, so that the position of the rotor in the radial plane can be regulated to a desired position. To determine the position of the rotor, it is known, for example from WO 2014/036419, to arrange a plurality of magnetic field sensors, for example Hall sensors, in the magnetic bearing device in such a way that they are arranged around the magnetically effective core of the rotor. The current position of the rotor is then determined as accurately as possible from the signals of the magnetic field sensors. However, since the magnetic field sensors detect all magnetic fields at their respective position, i.e., for example also the stator magnetic field, it is often very difficult to determine the exact position of the rotor in the radial plane from the signals of the magnetic field sensors.

Starting from this state of the art, it is therefore an object of the disclosure to propose a magnetic levitation device for contactless magnetic levitation of a rotor with a ring-shaped or disk-shaped magnetically effective core, in which the position of the rotor can be determined reliably and with very high accuracy by magnetic field sensors. Furthermore, it is an object of the disclosure to propose a centrifugal pump with such a magnetic levitation device.

The subject matter of the disclosure meeting this object is characterized by the features disclosed herein.

According to the disclosure, a magnetic levitation device is thus proposed for contactless magnetic levitation of a rotor comprising a disk-shaped or ring-shaped magnetically effective core, wherein the magnetic levitation device has a stator which comprises a plurality of coil cores, each of which comprises a longitudinal leg extending from a first end in an axial direction to a second end, and a transverse leg which is arranged at the second end of the longitudinal leg and which extends in a radial direction perpendicular to the axial direction, wherein at least one concentrated winding is provided at each longitudinal leg, which winding surrounds the respective longitudinal leg, wherein the stator further has a cup-shaped recess into which the rotor can be inserted, wherein the cup-shaped recess is arranged at an axial end of the stator, wherein the transverse legs are arranged around the cup-shaped recess, and wherein a plurality of magnetic field sensors for determining the position of the rotor is arranged around the cup-shaped recess. A ring-shaped holding device is provided for the magnetic field sensors, which has a cavity for each magnetic field sensor, which cavity is delimited with respect to the radial direction by an inside wall and by an outside wall, wherein the magnetic field sensor can be pushed into the cavity, and wherein the cavity is dimensioned such that the inside wall and the outside wall rest flat against the magnetic field sensor.

Due to the fact that a ring-shaped holder is provided, which has a cavity for each magnetic field sensor, which is dimensioned such that the inside wall and the outside wall rest flat against the magnetic field sensor, the respective position of the magnetic field sensor is known with an extremely high degree of accuracy. In particular, the position of the magnetic field sensors relative to the cup-shaped recess is known with a high degree of accuracy, which enables a very precise determination of the position of the rotor in the cup-shaped recess. In particular, the position of the respective magnetic field sensor is only defined by the position of the cavity and does not depend on how, for example, the magnetic field sensor is soldered to a circuit board or glued to a structure. Even if the position of a magnetic field sensor is determined by such connections as soldering or gluing, this generally results in an inaccuracy of the placement, which has a negative effect on the accuracy of the determination of the position of the rotor. Since in the embodiment according to the disclosure soldered or glued connections cannot influence the position of the magnetic field sensor, this results in a very high accuracy of the determination of the rotor position.

According to a preferred embodiment, a circuit board is arranged between the windings and the transverse legs with respect to the axial direction, on which circuit board all magnetic field sensors are arranged, and the holding device is designed for receiving the circuit board. This has the advantage that all magnetic field sensors can first be connected to the circuit board, whereby the electrical connections for controlling the magnetic field sensors and for receiving the measurement signals are created on the circuit board. Subsequently, the circuit board with the magnetic field sensors connected to it is then inserted into the holding device, wherein the magnetic field sensors are pushed into the cavities. Finally, the circuit board is firmly connected to the holding device, for example by screws and/or by a potting compound with which the holding device is poured.

Here, it is preferred that the holding device has a ring-shaped edge with a shoulder provided thereon, wherein the shoulder is arranged radially inwardly with respect to the edge, and wherein the circuit board rests against the shoulder. This shoulder thus forms a support for the circuit board so that it can be placed in the holding device in a very simple way.

Furthermore, it is preferred that the edge is designed in such a way that it projects beyond the circuit board with respect to the axial direction. Due to this measure, it is possible to pour the holding device with a potting compound, wherein the circuit board is completely covered by the potting compound.

According to a preferred embodiment, the holding device has a separate notch for each coil core, which encloses the coil core and receives the transverse leg of the coil core.

In this case it is advantageous that each cavity is arranged between two adjacent notches with respect to the circumferential direction. This makes it possible that each magnetic field sensor is arranged in each case between two adjacent coil cores with respect to the circumferential direction.

According to a particularly preferred embodiment, exactly six coil cores are provided in the magnetic levitation device.

Furthermore, it is preferred that the magnetic levitation device comprises exactly six magnetic field sensors, which are preferably arranged equidistantly around the cup-shaped recess.

In a preferred embodiment, the holding device is filled with a first potting compound in such a way that the circuit board is completely covered by the potting compound. The first potting compound is preferably a soft potting compound. In the context of this application, a soft potting compound means a potting compound which has a Shore hardness D of less than 40. For example, a silicone or a polyurethane is suitable as the first potting compound.

According to a particularly preferred embodiment, the coil cores with the windings arranged thereon are arranged in a housing, which is poured with a second potting compound, wherein the second potting compound is a thermally conductive potting compound. This second, thermally conductive potting compound is a hard thermal potting compound, for example an epoxy resin. As a result, the first potting compound and the second thermal potting compound are different from each other. During operation of the magnetic levitation device, strong and frequent temperature fluctuations can occur, particularly in the area of the holding device with the magnetic field sensors arranged in it. A soft potting compound is more resistant to such fluctuations. Therefore, a soft potting compound is preferred for pouring the holding device, which is softer than the hard potting compound with which the housing is poured. The second potting compound, which in particular encloses the coil cores and the windings arranged thereon, preferably has a particularly good thermal conductivity to dissipate the generated heat, e.g. the heat generated by copper losses and iron losses, as efficiently as possible. In order to achieve a high thermal conductivity, filling materials with good thermal conductivity are preferably added to the second thermal potting compound, for example graphite powder, carbon fibers, carbon nanotubes, aluminum oxide powder, boron nitride powder or other ceramic powders. These filling materials improve the thermal conductivity, but also cause a higher hardness of the hardened potting compound. Therefore, the second thermal potting compound has a greater hardness, in particular a greater Shore hardness D, than the first potting compound.

With regard to positioning the magnetic field sensors as accurately as possible, it is advantageous that a separate guide element is provided for each cavity, which forms the inside wall or the outside wall by which the cavity is delimited. Such separate guide elements are usually easier to manufacture with a very high accuracy than the entire holding device, which is manufactured by an injection molding process, for example. To form the cavity for the magnetic field sensor, the separate guide element is inserted in the axial direction into a recess in the holding device provided for this purpose, so that it then forms the inside wall or the outside wall which delimits the cavity with respect to the radial direction. Preferably, the separate guide element is connected to the holding device in a form-locking way, for example by a press fit.

Preferably, the stator has a containment can which forms an axial end of the stator, wherein the containment can has the cup-shaped recess into which the rotor can be inserted, and wherein the containment can embraces the holding device radially outwardly. In this preferred embodiment, the containment can is preferably designed as a separate containment can, which has the cup-shaped recess. For constructional reasons in particular, it is preferred that the containment can embraces the second holding device radially outwardly. In this case, an axial end area of the second holding device is arranged inside the containment can and is completely enclosed by it when viewed in the circumferential direction.

Preferably, the holding device is made of a plastic. For example, the holding device is designed as an injection molded part that is manufactured by an injection molding process.

Furthermore, it is preferred that the containment can is made of a plastic. The containment can can also be designed as an injection molded part.

According to a preferred embodiment, the magnetic levitation device has a housing comprising a stator housing and a control housing, which are arranged adjacent to each other with respect to the axial direction, wherein the stator housing is designed for receiving the coil cores with the concentrated windings arranged thereon, and the control housing is designed for receiving a control unit for controlling and supplying the windings with electrical energy for the generation of electromagnetic fields.

Preferably, the housing is designed in such a way that the coil cores with the concentrated windings arranged thereon can be inserted into the stator housing in a first installation direction in the axial direction, and the control unit can be inserted into the control housing in a second installation direction, wherein the first installation direction is directed in the opposite direction to the second installation direction. The housing preferably has two areas separated from each other, one of which forms the stator housing and the other the control housing. For example, these two areas can be separated from each other by a wall which has passages, e.g. for electrical connections. Then, the housing is preferably designed in one piece with respect to the circumferential direction.

According to a particularly preferred embodiment, the stator of the magnetic levitation device is designed to generate a torque with which the rotor can be driven magnetically without contact for rotation about the axial direction.

Furthermore, a centrifugal pump for conveying a fluid is proposed by the disclosure, which comprises a magnetic levitation device according to the disclosure, as well as a rotor with a magnetically effective core, wherein the rotor can be inserted into the cup-shaped recess of the containment can, and wherein the rotor is designed as the rotor of the centrifugal pump.

Further advantageous measures and embodiments of the disclosure are apparent from the present disclosure.

### BRIEF DESCRIPTION OF THE DRAWINGS

In the following, the disclosure will be explained in more detail with reference to embodiments and with reference to the drawings.

FIG. 1 is a sectional representation of an embodiment of a magnetic levitation device according to the disclosure,

FIG. 2 is a perspective representation of the embodiment from FIG. 1 in a perspective exploded view,

FIG. 3 is a perspective representation of the stator and the holding device,

FIG. 4 is a perspective exploded view of the coil cores, the windings and the holding device,

FIG. 5 is a perspective representation of the holding device from the direction of the first ends of the longitudinal legs of the coil cores,

FIG. 6 is similar to FIG. 5, but from the opposite viewing direction,

FIG. 7 is a perspective exploded view of the holding device and the circuit board with the magnetic field sensors,

FIG. 8 is a sectional representation of the holding device with the circuit board inserted in it,

FIG. 9 is the detail I from FIG. 8 in an enlarged representation,

FIG. 10 is a perspective representation of the guide element from FIG. 9,

FIG. 11 is a sectional representation of the containment can of the stator, and

FIG. 12 is a schematic sectional representation of an embodiment of a centrifugal pump according to the disclosure in a section in the axial direction.

### DETAILED DESCRIPTION

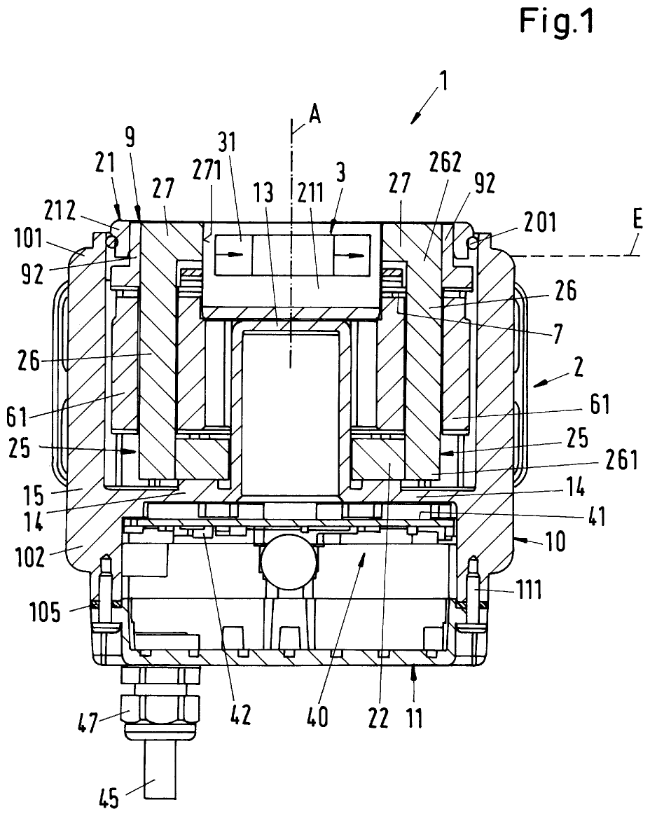

FIG. 1 shows a sectional representation of an embodiment of a magnetic levitation device according to the disclosure, which is designated in its entirety by the reference sign 1. The magnetic levitation device 1 is designed for the contactless magnetic levitation of a rotor 3, which comprises a disk-shaped or ring-shaped magnetically effective core 31.

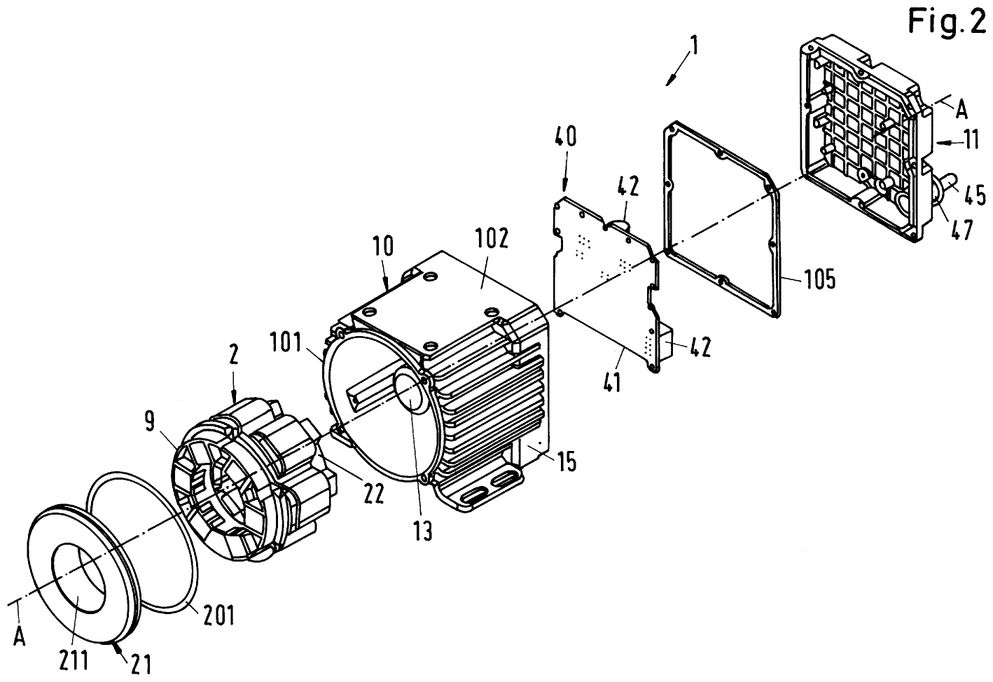

For better understanding, FIG. 2 still shows a perspective representation of the embodiment from FIG. 1 in a perspective exploded view, whereby the rotor 3 is not represented in FIG. 2. The magnetic levitation device 1 is designed according to the temple construction and comprises a stator 2, which has a plurality of coil cores 25—here six coil cores 25—each of which comprises a longitudinal leg 26, which extends from a first end 261 in an axial direction A to a second end 262, and a transverse leg 27 arranged perpendicular to the longitudinal leg 26, which extends in a radial direction which is perpendicular to the axial direction A. Each transverse leg 27 is delimited with respect to the radial direction by an end face 271, which forms the pole of the associated coil core 25.

At least one concentrated winding 61 is provided on each longitudinal leg 25, in this embodiment exactly one, which surrounds the respective longitudinal leg 26.

The magnetic levitation device 1 comprises a housing 10 in which the coil cores 25 are arranged.

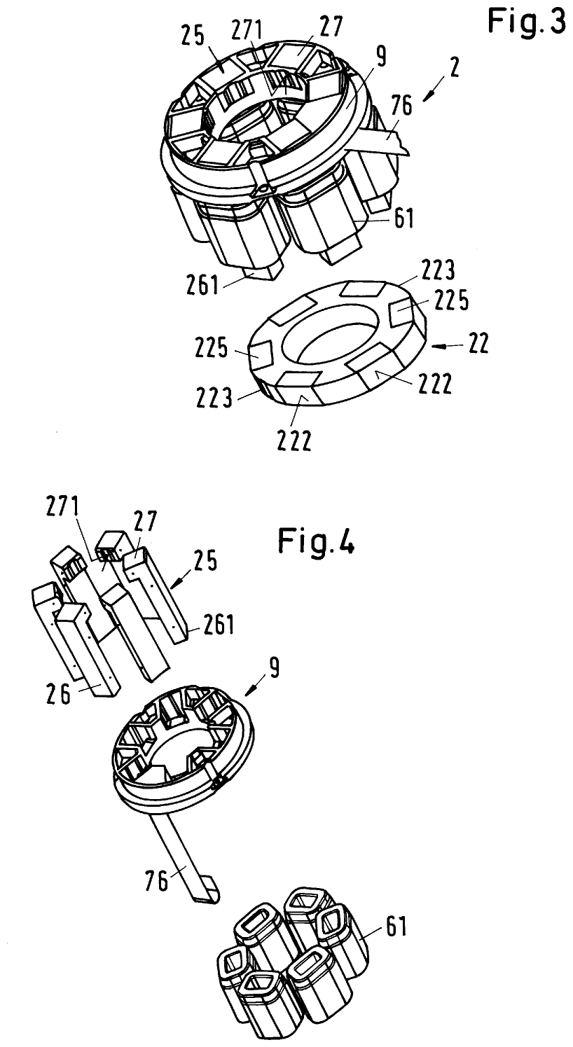

For better understanding, FIG. 3 and FIG. 4 show further representations of the stator 2 of the embodiment of the magnetic levitation device 1, whereby the housing 10 is not represented. FIG. 3 shows a perspective representation of the stator 2 and a holding device 9, which will be described in more detail. Furthermore, in FIG. 3 a back iron 22 is provided, which connects all first ends 261 of the longitudinal legs 26 to one another—i.e. the lower ends 261 according to the representation (FIG. 1)—and serves to conduct the magnetic flux. The back iron 22 is preferably designed in a ring-shaped manner. FIG. 4 shows a perspective exploded view of the coil cores 25 with the concentrated windings 61 arranged thereon and the holding device 9.

The housing 10 is preferably made of a metallic material, for example aluminum or stainless steel. For better chemical resistance, the housing 10 can be provided with a coating, preferably with a plastic coating made of a highly chemically resistant plastic. Examples of such plastics are PTFE (polytetrafluoroethylene), PFA (perfluoroalkoxy polymers), ECTFE (ethylene chlorotrifluoroethylene), ETFE (ethylene tetrafluoroethylene), epoxy resin (polyepoxy), PPA (polyphthalamide), PE (polyethylene). Depending on the intended application, the housing 10 can also be made of titanium or chrome steel.

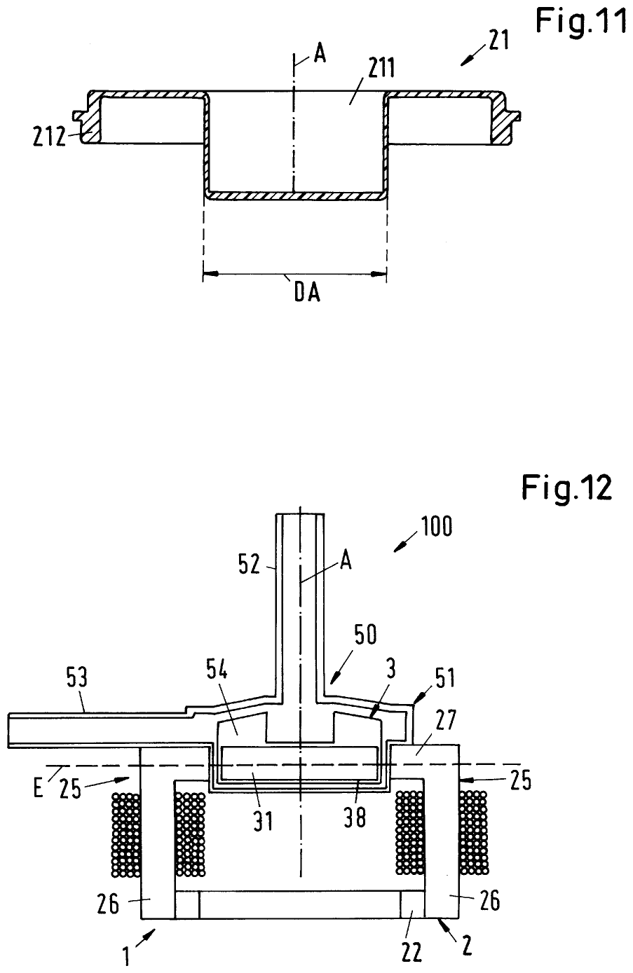

The stator 2 further comprises a containment can 21 with a cup-shaped recess 211 (see also FIG. 11), into which the rotor 3 to be levitated can be inserted (see FIG. 1). The containment can 21 forms one of the two axial ends of the stator 2 or the magnetic levitation device 1, according to the representation in FIG. 1 the upper axial end of the stator 2. A housing cover 11, which closes the housing 10, is arranged at the other axial end of the magnetic levitation device 1.

The containment can 21 is firmly connected to the housing 10, for example by a form-locking connection and/or by an elastic seal 201. Preferably, the containment can 21 is connected to the housing 10 in a hermetically sealed manner. The housing cover 11 is firmly connected to the housing 10, for example by screws 111 (FIG. 1), whereby a sealing element 105 is optionally arranged between the housing cover 11 and the housing 10. The sealing element 105 can in particular be designed as a flat sealing. Preferably, the housing cover 11 is connected to the housing 10 in a hermetically sealed manner.

Particularly preferably, the housing 10 together with the containment can 21 and the housing cover 11 forms a hermetically sealed housing in which the other components of the stator 2 are encapsulated in a hermetically sealed manner. The housing 10 is preferably filled with a potting compound with good thermal conductivity, for example with an epoxy resin, so that the components arranged inside the housing 10 are surrounded by the potting compound. In this way, the general thermal resistance is reduced and vibrations are dampened.

Preferably, the housing cover is made of a plastic. A chemically resistant plastic such as polypropylene is preferred, particularly for applications in chemically aggressive environments.

The transverse legs 27 of the coil cores 25 are arranged in the containment can 21 in such a way that the end faces 271 of the transverse legs 27 are arranged around the cup-shaped recess 211.

The coil cores 25 of the stator 2 are arranged equidistantly on a circular line, so that the end faces 271 surround the magnetically effective core 31 of the rotor 3 when the rotor 3 is inserted into the cup-shaped recess 211. Exactly one concentrated winding 61 is provided in each case at each longitudinal leg 26, which surrounds the longitudinal leg 26.

In other embodiments, more than one concentrated winding can also be arranged at the longitudinal legs 26. For example, there are embodiments in which exactly two concentrated windings are provided in each case at each of the longitudinal legs 26, each of which surrounds the respective longitudinal leg 26, wherein the two windings arranged on the same longitudinal leg 26 are arranged adjacent to each other with respect to the axial direction A.

The concentrated windings 61 serve to generate electromagnetic fields with which the rotor 3 can be magnetically levitated without contact in the cup-shaped recess 211 of the containment can 21.

Furthermore, a control unit 40 is provided for controlling and supplying the windings 61 with electrical energy. The control unit 40 comprises in particular the power electronics, for example the inverters or the rectifiers, which feed the required currents into the windings 61. The control unit 40 is represented in FIG. 1 and FIG. 2. Particularly preferably, the control unit 40 is also arranged inside the housing 10, for example according to the representation (FIG. 1) below the first ends 261 of the longitudinal legs 26 of the coil cores 25. The control unit 40 is preferably also encapsulated with a thermal potting compound or coupled to the housing 10 and the back iron 22 and/or the coil cores 25 of the stator 2. Preferably, the control unit 40 comprises an electronics board 41 on which various electronic components 42 are arranged.

As can be recognized in particular in FIG. 1 and FIG. 2, the housing 10 preferably comprises two areas which are separate from each other and arranged adjacent to each other with respect to the axial direction A, one of which forms a stator housing 101 and the other a control housing 102. The stator housing 101 of the housing 10 is designed for receiving the coil cores 25 with the windings 61 arranged thereon, and the control housing 102 is designed for receiving the control unit 40.

According to a preferred measure, the housing 10 comprises an inner cup 13 which is substantially designed in a cylindrical manner, and which is arranged radially inwards with respect to the windings 61 in the interior space surrounded by the windings 61. The inner cup 13 is connected to an outer wall 15 of the housing 10 via a flange-like projection 14. The outer wall 15 forms the radially outer boundary of the housing 10. Particularly preferably, the inner cup 13 and the flange-like projection 14 are an integral part of the housing 10. The outer wall 15, the flange-like projection 14 and the inner cup 13 are designed in one piece as a whole and form the preferably one-piece housing 10.

The inner cup 13 and the flange-like projection 14 separate the area of the housing 10 which forms the stator housing 101 from the area that forms the control housing 102.

The inner cup 13 connected to the flange-like projection 14 extends from the radially inner edge of the flange-like projection 14 in the axial direction A and is arranged radially inwardly with respect to the windings 61 and the back iron 22 in the interior space surrounded by the windings 61, as can be recognized in particular in FIG. 1. With respect to the radial direction, the inner cup 13 is arranged adjacent to the longitudinal legs 26 of the coil cores 25 or the windings 61 arranged thereon, so that the inner cup 13 can absorb and dissipate the heat generated by the windings 61 and the coil cores 25 particularly well. With respect to the axial direction A, the inner cup 13 extends approximately up to the cup-shaped recess 211 of the containment can 21.

As can be recognized in particular in FIG. 2, the stator housing 101 of the housing 10 is designed with an interior space which has a substantially circular or ring-shaped cross-sectional area perpendicular to the axial direction A. This is preferred because the stator housing 101 can thus receive the ring-shaped back iron 22 with the coil cores 25 arranged around the back iron 22 particularly well. The control housing 102 of the housing 10 is designed with an interior space which has a substantially rectangular or square cross-sectional area perpendicular to the axial direction A. This is preferred because the control housing 102 is thus particularly well suited to receive the preferably rectangularly or squarely designed electronics board 41 of the control unit 40. Particularly with respect to manufacturing, a rectangular or square design of the electronics board 41 is much simpler than, for example, a round design.

Due to this embodiment of the stator housing 101 and the control housing 102, the axial end of the stator 2, at which the containment can 21 closes the housing 10, has a substantially round cross-section, so that the containment can 21 has a round or circular ring-shaped design. In contrast, the axial end of the stator 2, at which the housing cover 11 closes the housing 10, has a substantially rectangular or square cross-section, so that the housing cover 11 has a rectangular or square design.

With an exemplary character, some components of the control unit 40 are represented in FIG. 1. For example, the control unit 40 comprises the electronics board 41 on which the electronic components 42 are provided, e.g. the power electronics for controlling the windings 61. For example, the electronics board 41 can further contain evaluation electronics for evaluating the signals from sensors, e.g. magnetic field sensors, or can serve as a communication interface. The electronics board 41 is preferably designed as an electronic print or PCB (printed circuit board). Furthermore, a connection cable 45 is provided, which is connected to the electronics board 41 via a cable connection (not represented) or a plug. The connection cable 45 leads out of the housing 10 and serves, for example, to supply power to the magnetic levitation device 1. The connection cable 45 is led out of the housing 20 by a sealingly designed cable bushing 47. Preferably, the cable bushing 47 is designed in a hermetically sealing manner.

The electronics board 41 of the control unit 40 is connected to the windings 61 via connecting lines (not represented), for example cables, in order to control them and supply them with energy. It is understood that feedthroughs or openings are provided between the control housing 102 and the stator housing 101, through which the connecting lines are passed. Such feedthroughs can, for example, be arranged in the flange-like projection 14 or in the inner cup 13.

The electronics board 41 is preferably arranged directly on the flange-like projection 14, so that the electronics board rests against the flange-like projection 14. In this way, it is possible in a particularly efficient way to dissipate the heat generated in the control unit 40 via the housing 10. Preferably, the main heat sources in the control unit 40, for example the circuit breakers for the windings 61, are arranged in the areas of the electronics board 41 that rest against the flange-like projection 14.

The interior space of the inner cup 13, i.e. the space enclosed by the inner cup 13, can be used for further electronic components, electronics boards or plugs or connections. These are not represented in FIG. 1 for reasons of a better overview.

According to an especially preferred embodiment, the stator 2 is designed in such a way that, in addition to the contactless magnetic levitation of the rotor 3, it can also exert a torque on the rotor 3 or the magnetically effective core 31 of the rotor 3, which drives the rotor 3 for a rotation about a desired axis of rotation. Here, the desired axis of rotation designates that axis about which the rotor 3 rotates in the operating state when the rotor 3 is in a centered and non-tilted position with respect to the stator 2, as is represented in FIG. 1. This desired axis of rotation extends in the axial direction A, i.e. in this preferred embodiment, the rotor 3 arranged in the containment can 21 of the stator 2 can be driven for rotation about the axial direction A. Normally, the desired axis of rotation coincides with the center axis of the stator 2, which extends in the axial direction A.

In this embodiment, the concentrated windings 61 thus generate electromagnetic rotating fields with which the rotor 3 can be both magnetically levitated without contact with respect to the stator 2 and can also be driven without contact for rotation about the axial direction A.

It is understood that the number of six coil cores 25, although preferred, is only to be understood as an example. Of course, such embodiments are also possible in which the stator 2 has fewer than six, e.g. five or four or three coil cores 25, or such embodiments in which the stator 2 has more than six, e.g. seven or eight or nine coil cores 25 or any larger number of coil cores 25.

The rotor 3 comprises the magnetically effective core 31, which is designed in a ring-shaped or disk-shaped manner. According to the representation in FIG. 1, the magnetically effective core 31 is designed as a ring and defines a magnetic center plane. Alternatively, the magnetically effective core 31 can also be designed as a disk. Normally, in the case of a disk-shaped or ring-shaped magnetically effective core 31, the magnetic center plane is the geometric center plane of the magnetically effective core 31 of the rotor 3, which is perpendicular to the axial direction A. In the operating state, the magnetically effective core 31 is levitated in a radial plane E, which stands perpendicular on the axial direction A. The radial plane is indicated in FIG. 1 by the line E, which stands perpendicular on the axial direction A. Thus, the radial plane E is that plane which stands perpendicular on the axial direction A and contains the line E.

The radial plane E is that plane in which the magnetically effective core 31 of the rotor 3 is actively magnetically levitated between the end faces 271 in the stator 2 in the operating state. If the rotor 3 is not tilted and is not deflected in the axial direction A, the magnetic center plane lies in the radial plane E. The radial plane E defines the x-y plane of a Cartesian coordinate system whose z-axis runs in axial direction A.

The radial position of the magnetically effective core 31 or the rotor 3 refers to the position of the rotor 3 in the radial plane E.

Since it is sufficient for the understanding of the disclosure, only the magnetically effective core 31 is represented from the rotor 3 in the drawing in FIG. 1. It is understood that the rotor 3 can of course also comprise further components such as jackets or encapsulations, which are preferably made of a plastic, or of a metal or of a metal alloy or of a ceramic or a ceramic material. Furthermore, the rotor 3 can also comprise vanes for mixing, stirring or pumping fluids (see e.g. FIG. 12) or other components.

When the rotor 3 is inserted into the cup-shaped recess 211 of the containment can 21, the rotor 3 and in particular the magnetically effective core 31 of the rotor 3 is surrounded by the radially outwardly arranged end faces 271 of the transverse legs 27 of the coil cores 25 of the stator 2. Thus, the transverse legs 27 form a plurality of pronounced stator poles—in this case six stator poles. The transverse legs 27 are arranged at the upper ends of the longitudinal legs 26 and in the radial plane E. Each transverse leg 27 extends in the radial direction towards the rotor 3.

When the magnetically effective core 31 of the rotor 3 is in its desired position during operation, the magnetically effective core 31 is centered between the end faces 271 of the transverse legs 27 so that the transverse legs 27 arranged in the radial plane E also lie in the magnetic center plane. According to the representation, the concentrated windings 61 are arranged below the radial plane E and are aligned such that their coil axes extend in the axial direction A.

All first ends 261 of the longitudinal legs 26—i.e., the lower ends 261 according to the representation (FIG. 1)—are connected to each other by a back iron 22. The back iron 22 is preferably designed in a ring-shaped manner. Such embodiments are possible (see FIG. 1, for example) in which the back iron 22 extends radially inwardly along all first ends 261 of the longitudinal legs 26.

In order to generate the electromagnetic fields required for the magnetic levitation of the rotor 3 and optionally for the generation of a torque on the rotor 3, the longitudinal legs 26 of the coil cores 25 carry the windings designed as concentrated windings 61.

In the operating state, those electromagnetic rotating fields are generated with these concentrated windings 61, with which an arbitrarily adjustable transverse force in the radial direction can be exerted on the rotor 3, so that the radial position of the rotor 3, i.e. its position in the radial plane E perpendicular to the axial direction A, can be actively controlled or regulated. Optionally, a torque is additionally effected on the rotor 3 with these electromagnetic rotating fields.

The “magnetically effective core 31” of the rotor 3 refers to that region of the rotor 3 which magnetically interacts with the stator 2 for the generation of magnetic levitation forces and optionally for torque generation.

As already mentioned, the magnetically effective core 31 is designed in a ring-shaped manner in this embodiment. Furthermore, the magnetically effective core 31 is designed in a permanent magnetic manner. For this purpose, the magnetically effective core 31 can comprise at least one permanent magnet, but also several permanent magnets, or—as in the embodiment described here—consist entirely of a permanent magnetic material, so that the magnetically effective core 31 is the permanent magnet. For example, the magnetically effective core 31 is magnetized in the radial direction.

Those ferromagnetic or ferrimagnetic materials, which are magnetically hard, that is which have a high coercive field strength, are typically called permanent magnets. The coercive field strength is that magnetic field strength which is required to demagnetize a material. Within the framework of this application, a permanent magnet is understood as a component or a material, which has a coercive field strength, more precisely a coercive field strength of the magnetic polarization, which amounts to more than 10′000 A/m.

Such embodiments are also possible in which the magnetically effective core 31 is designed in a permanent magnet-free manner, i.e., without permanent magnets. The rotor 3 is then designed, for example, as a reluctance rotor. Then, the magnetically effective core 31 of the rotor 3 is made of a soft magnetic material, for example. Suitable soft magnetic materials for the magnetically effective core 31 are, for example, ferromagnetic or ferrimagnetic materials, i.e., in particular iron, nickel-iron, cobalt-iron, silicon iron, mu-metal.

Furthermore, embodiments are possible in which the magnetically effective core 31 of the rotor 3 comprises both ferromagnetic materials and permanent magnetic materials. For example, permanent magnets can be placed or inserted into a ferromagnetic base body. Such embodiments are advantageous, for example, if one wishes to reduce the costs of large rotors by saving permanent magnetic material.

Embodiments are also possible in which the rotor is designed according to the principle of a cage rotor.

Both the ring-shaped back iron 22 and the coil cores 25 of the stator 2 are each made of a soft magnetic material because they serve as flux conducting elements to conduct the magnetic flux.

Suitable soft magnetic materials for the coil cores 25 and the back iron 22 are, for example, ferromagnetic or ferrimagnetic materials, i.e., in particular iron, nickel-iron, cobalt-iron, silicon iron or mu-metal. In this case, for the stator 2, a design as a stator sheet stack is preferred, in which the coil cores 25 and the back iron 22 are designed in sheet metal, i.e., they consist of several thin sheet metal elements, which are stacked.

Furthermore, it is possible that the coil cores 25 and the back iron 22 include pressed and subsequently sintered grains of the aforementioned materials. The metallic grains are preferably embedded in a plastic matrix so that they are at least partially insulated from one another, whereby eddy current losses can be minimized. Thus, soft magnetic composites including electrically insulated and compressed metal particles are also suitable for the stator. In particular, these soft magnetic composites, which are also designated as SMC (Soft Magnetic Composites), can include iron powder particles which are coated with an electrically insulating layer. These SMC are then formed into the desired shape by powder metallurgy processes.

During operation of the magnetic levitation device 1, the magnetically effective core 31 of the rotor 3 interacts with the stator 2 in such a way that the rotor 3 can be magnetically levitated without contact with respect to the stator 2 and preferably can also be magnetically set in rotation without contact about the axial direction A. In this case, it is particularly advantageous that the same windings 61, with which the magnetic levitation of the rotor 3 is effected, also serve to generate a torque on the rotor 3. Preferably, three degrees of freedom of the rotor 3 can then be actively regulated, namely its position in the radial plane E and its rotation. With respect to its axial deflection from the radial plane E in the axial direction A, the magnetically effective core 31 of the rotor 3 is passively magnetically stabilized by reluctance forces, i.e., it cannot be controlled. The magnetically effective core 31 of the rotor 3 is also passively magnetically stabilized with respect to the remaining two degrees of freedom, namely tilting with respect to the radial plane E perpendicular to the desired axis of rotation. By the interaction of the magnetically effective core 31 with the coil cores 25, the rotor 3 is thus passively magnetically levitated or passively magnetically stabilized in the axial direction A and against tilting (a total of three degrees of freedom) and actively magnetically levitated in the radial plane (two degrees of freedom).

As is generally the case, an active magnetic levitation is also referred to in the framework of this application as one which can be actively controlled or regulated, for example by the electromagnetic fields generated by the concentrated windings 61. A passive magnetic levitation or a passive magnetic stabilization is one that cannot be controlled or regulated. The passive magnetic levitation or stabilization is based, for example, on reluctance forces, which bring the rotor 3 back again to its desired position when it is deflected from its desired position, i.e., for example, when it is displaced or deflected in the axial direction A or when it is tilted.

In the magnetic levitation device 1, in contrast to classic magnetic bearings, the magnetic levitation—and optionally the generation of a torque acting on the rotor—is realized by electromagnetic rotating fields. For the combined generation of the magnetic levitation forces and a torque for rotating the rotor 3 about the axial direction A, it is possible on the one hand—as shown in FIG. 1—to arrange exactly one concentrated winding 61 at each longitudinal leg 26.

On the other hand, embodiments are possible in which two different winding systems are provided for the combined generation of the magnetic levitation forces and a torque for rotating the rotor 3. For this purpose, for example, exactly two concentrated windings are arranged in each case at each longitudinal leg, which are arranged adjacent to each other with respect to the axial direction A. One of these two windings belongs to the first of the two winding systems and the other to the second of the two winding systems.

In the embodiment represented in FIG. 1 with exactly one concentrated winding 61 at each coil core 25, the values for the current required for the levitation and the current required for the generation of the torque determined in each case, for example, in the control unit 40 are added or superimposed by calculation—e.g., with the aid of software. Then, the resulting total current is impressed into the respective concentrated winding 61.

For better understanding, the back iron 22 is represented separately from the coil cores 25 in FIG. 3. The back iron 22 is substantially designed in a ring-shaped manner and extends radially inwards along the first ends 261 of the longitudinal legs 26 in the assembled state (see also FIG. 1). Preferably, the back iron 22 is designed in sheet metal. In the sheet-metal embodiment, the back iron 22 is made of a plurality of thin elements which are stacked parallel to each other in the axial direction. All elements are identically designed, in this case substantially ring-shaped and also with the same thickness in each case.

On its radially outer circumferential surface, the back iron 22 has a plurality of flattenings 222, which are designed in a planar manner, i.e. not curved. In the assembled state of the stator 2, a first end 261 of one of the longitudinal legs 26, which preferably have a rectangular profile, rests against each of these flattenings 222 in each case. Due to the planar design of the flattenings 222, a large contact surface between the back iron 22 and the longitudinal legs 26 of the coil cores 25 is ensured, resulting in a particularly good conducting of the magnetic flux or a very low magnetic resistance at the transition between the back iron 22 and the longitudinal legs 26. The flattenings can also be arranged at separate segments 225, wherein the separate segments 225 are arranged in grooves of the back iron 22. The grooves are dimensioned such that the separate segments 225 are flush with the rest of the back iron 22.

Preferably, the number of flattenings 222 is the same as the number of the coil cores 25, i.e. six flattenings 222 are provided here, which are distributed equidistantly along the outer circumference of the back iron 22.

Furthermore, one or more venting holes or venting recesses 223 can be provided at the back iron 22, which extend completely through the back iron 22 with respect to the axial direction A. Air can escape through the venting recesses 223, for example when filling the housing 20 with a thermally conductive potting compound.

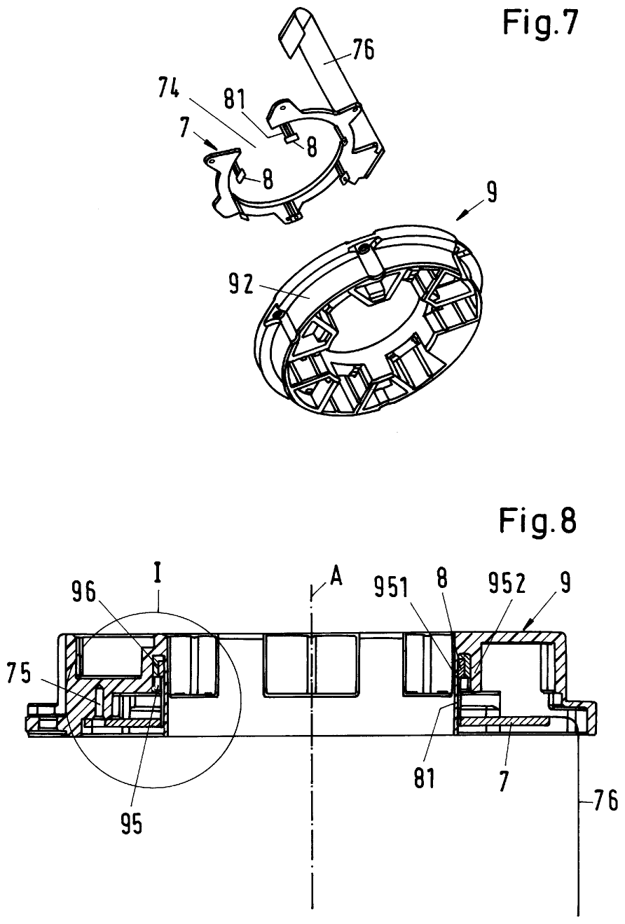

In order to determine the current position of the rotor 3 in the cup-shaped recess 211, the magnetic levitation device 1 comprises a plurality—here six—of magnetic field sensors 8 (see also FIG. 7), which are arranged around the cup-shaped recess 211 in the assembled state of the magnetic levitation device 1. The magnetic field sensors 8 are sensors with which a magnetic field can be measured. In particular, the following sensor types are suitable as magnetic field sensors 8: Hall sensors or magnetoresistive sensors or GMR sensors (GMR: giant magnetoresistance). With the aid of the magnetic field sensors 8, the current position of the rotor 3 in the cup-shaped recess 211 of the containment can 21 or in the radial plane E can be determined in a manner known per se.

According to a particularly preferred embodiment which is represented in FIG. 7, all magnetic field sensors 8 are arranged on a circuit board 7 and are signal-connected to it via electrical connections 81, so that all magnetic field sensors 8 can be controlled via the circuit board 7 and the signals measured by the magnetic field sensors 8 can be received and processed via the circuit board 7 or, for example, transmitted to the control unit 40.

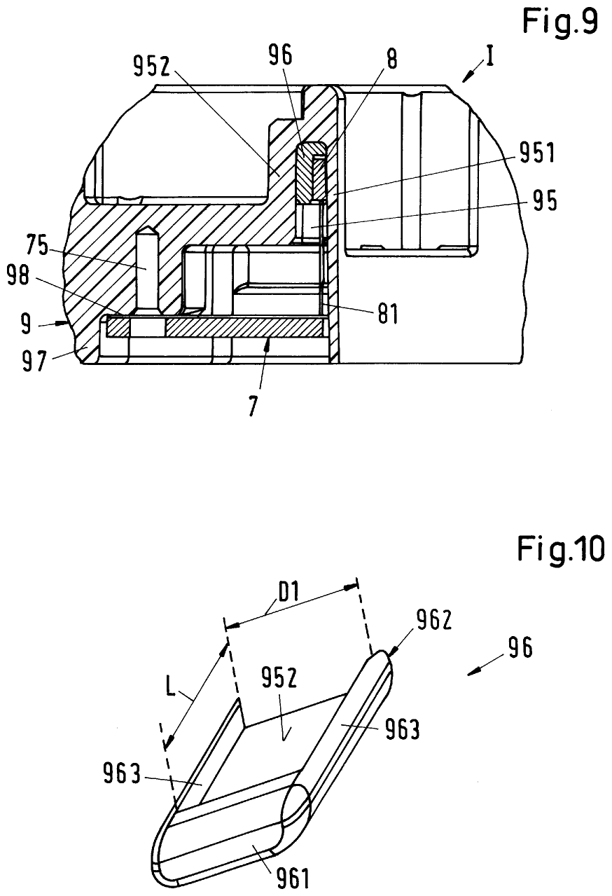

The circuit board 7 is arranged with respect to the axial direction A between the windings 61 on the one hand and the transverse legs 27 on the other hand. The holding device 9 also represented in FIG. 7 is designed for receiving the circuit board 7. Preferably, the circuit board 7 can be attached to the holding device 9, for example by a plurality of screws 75 (see FIG. 9).

The circuit board 7 is preferably designed as an electronic print or PCB (printed circuit board). The magnetic field sensors 8 and the electrical connections 81 are attached to the circuit board 7, for example by a soldered connection. Furthermore, such components can be provided on the circuit board 7 which are used for controlling the magnetic field sensors and/or for the evaluation of the measurement signals determined by the magnetic field sensors 8.

The circuit board 7 is substantially designed in a ring-shaped manner and arranged parallel to the radial plane E. As can be recognized in FIG. 7, the circuit board 7 is not designed as a closed ring but with a ring segment-shaped opening 74, so that the circuit board 7 has two ends when viewed in the circumferential direction. Preferably, the circuit board 7 is arranged radially on the inside with respect to the longitudinal legs 26 of the coil cores 25, in such a way that the magnetic field sensors 8 are arranged around the cup-shaped recess 211 of the containment can 21. Particularly preferably, the magnetic field sensors 8 are arranged equidistantly on the circuit board 7 with respect to the circumferential direction.

The circuit board 7 further comprises an electrical connecting element 76, which connects the circuit board 7 to the control unit 40, so that the control unit 40 and the circuit board 7 can exchange electrical voltages or currents via the electrical connecting element 76. The electrical connecting element 76 is preferably designed as a flexprint. Of course, the electrical connecting element 76 can also be designed in a different manner, for example as a cable, a cable bundle, or a flat ribbon cable.

As already mentioned, the magnetic levitation device 1 further comprises the holding device 9. The holding device 9 serves a particularly simple yet precise mounting of the magnetic levitation device 1 and a very precise positioning of the magnetic field sensors 8 relative to the cup-shaped recess 211, in which the rotor 3 is arranged in the operating state.

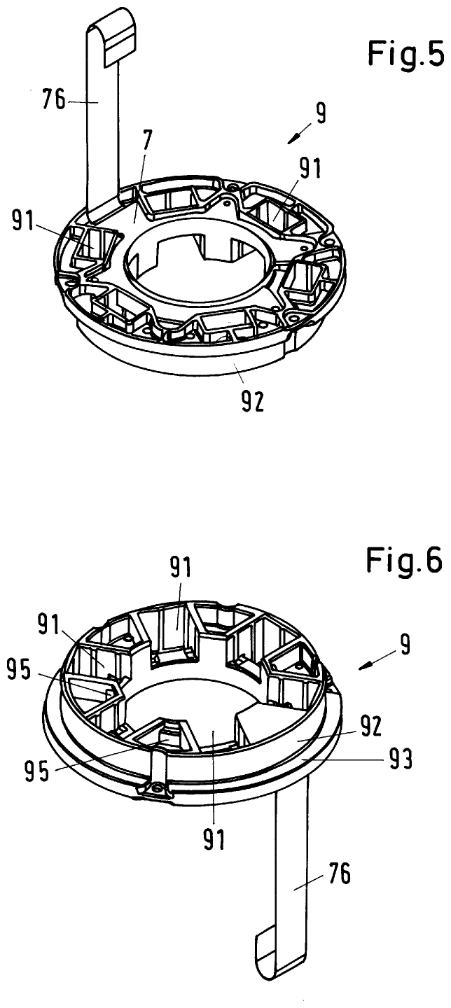

In the following, the holding device 9 is explained with reference to several figures. FIG. 5 shows the holding device 9 in a perspective representation, wherein the viewing direction is from the direction of the first ends 261 of the longitudinal legs 26. According to the representation in FIG. 1, the view is therefore directed at the holding device 9 from below. FIG. 6 shows the holding device 9 in a perspective representation, wherein the viewing direction is opposite to the viewing direction in FIG. 5. According to the representation in FIG. 1, the view in FIG. 6 is therefore directed at the holding device 9 from above. Both FIG. 5 and FIG. 6 show the holding device 9 with the circuit board 7 arranged in the holding device 9. FIG. 8 shows a sectional representation of the holding device 9 with the circuit board 7 inserted therein. For better understanding, FIG. 9 also shows an enlarged representation of the detail I from FIG. 8.

The holding device 9 is substantially designed in a plate-shaped and ring-shaped manner and comprises several notches 91 for receiving the transverse legs 27 of the coil cores 25. Exactly one notch 91 is provided for each transverse leg 27, so that the number of notches 91 is equal to the number of coil cores 25. The holding device 9 is inserted into the containment can 21 (see FIG. 1) and extends from the bottom of the containment can 21 in the axial direction A to a lower edge according to the representation (FIG. 1), which is arranged above the windings 61 with respect to the axial direction A according to the representation.

The holding device 9 is designed in a ring-shaped manner in such a way that it can be arranged around the cup-shaped recess 211 of the containment can 21, i.e. the cup-shaped recess 211 is enclosed radially on the outside by the holding device 9.

The holding device 9 has an axial edge area 92 which has an outer diameter which is smaller than the diameter of the rest of the holding device 9. According to the representation in FIG. 6, this axial edge area 92 is the upper axial edge area. With respect to the axial direction A, the axial edge area 92 ends at a projection 93, at which the outer diameter of the second holding device 9 increases. The embodiment with the axial edge area 92 of smaller diameter and the projection 93 serves to ensure that the containment can 21 can enclose the holding device 9 radially on the outside. This can be recognized in particular in FIG. 1. The containment can 21 has a radially outer edge 212 which, in the assembled state, embraces the axial edge region 92 of the second holding device 9. The radially outer edge 212 is designed to be so long with respect to the axial direction A that it extends at most as far as the projection 93.

The holding device 9 is preferably made of a plastic and in particular preferably of a plastic that can be processed by injection molding. The holding device 9 is thus preferably designed as an injection-molded part. Suitable plastics for the manufacture of the holding device 9 are, for example, acrylonitrile-butadiene-styrene (ABS), polyamide (nylon, PA), polypropylene (PP) or fiber-filled polypropylene.

The holding device 9 serves both as a holder for the circuit board 7 and as a holder for the magnetic field sensors 8, with which holder the magnetic field sensors 8 can be placed very precisely relative to the cup-shaped recess 211. For this purpose, a cavity 95 is provided in each case in the holding device 9 for each magnetic field sensor 8, which is delimited with respect to the radial direction by an inside wall 951 and by an outside wall 952, wherein the magnetic field sensor 8 can be pushed into the cavity 95, and wherein the cavity 95 is dimensioned such that the inside wall 951 and the outside wall 952 rest flat against the magnetic field sensor 8. This can be recognized best in FIG. 9.

Here, it is a substantial aspect that both the inside wall 951 and the outside wall 952 of the cavity 95 rest flat against the magnetic field sensor 8, as this means that the position of the magnetic field sensor 8 relative to the cup-shaped recess 211 is known with a very high degree of accuracy. The magnetic field sensors 8 are preferably designed in a rectangular manner. The cavity 95 is dimensioned such that the magnetic field sensor 8 can be fully inserted into the cavity 95 with respect to the axial direction A. Thus, the cavity 95 forms a pocket for the magnetic field sensor 8, which is at least as deep with respect to the axial direction A as the extension of the magnetic field sensor 8 in the axial direction A. The width of this pocket in the radial direction, i.e. the distance measured in the radial direction between the inside wall 951 and the outside wall 952, is dimensioned such that it corresponds to the extension of the magnetic field sensor 8 in the radial direction, so that the magnetic field sensor 8 can be pushed into the cavity 95 in the axial direction and the inside wall 951 and the outside wall 952 of the cavity 95 then rest flat against the magnetic field sensor 8.

Due to this embodiment, in which the magnetic field sensor 8 is enclosed on three sides by the cavity 95, on the one hand the position of the magnetic field sensor 8 is known with a very high degree of accuracy and on the other hand, the magnetic field sensor 8 arranged in the cavity 95 is also very well protected.

In order to facilitate the insertion of the magnetic field sensors 8 into the cavities 95 during assembly, it can be advantageous to design the inside wall 951 and/or the outside wall 952 slightly obliquely to the axial direction, so that the cavity 95 is designed in a slightly conical manner when viewed in the axial direction A, whereby the cavity 95 tapers upwards with respect to the representation in FIG. 9.

Furthermore, it is preferred that each magnetic field sensor 8 is arranged as close as possible to the cup-shaped recess 211. For this purpose, the inner diameter of the holding device 9 is dimensioned such that it is the same size or only very slightly larger than the outer diameter DA (FIG. 11) of the cup-shaped recess 211 of the containment can 21. Then, in the assembled state, the wall of the holding device 9, which forms the inside walls 951 of the cavities 95, rests against the cup-shaped recess 211 of the containment can 21. Viewed in the radial direction, the inside wall 951, which delimits the cavity 95, is thus arranged in each case between the cup-shaped recess 211 of the containment can 21 and the magnetic field sensor 8.

Since the magnetic field sensors 8 are preferably arranged equidistantly on the circuit board 7 with respect to the circumferential direction, the six cavities 95 for the six magnetic field sensors 8 are also preferably arranged equidistantly with respect to the circumferential direction of the holding device 9. Particularly preferably, exactly one cavity 95 is arranged in each case between two notches 91 adjacent in the circumferential direction. In the assembled state, each magnetic field sensor 8 is then arranged in each case between two coil cores 25 adjacent in the circumferential direction.

With regard to the highest possible accuracy of the position of the magnetic field sensors 8 relative to the cup-shaped recess 211, it is a preferred measure to provide in each case a separate guide element 96 for each cavity 95, which forms the inside wall 951 or the outside wall 952 by which the cavity 95 is delimited.

In FIG. 9, an embodiment is shown in which the guide element 96 forms the outside wall 952 of the cavity 95. For better understanding, FIG. 10 still shows a perspective representation of the separate guide element 96 from FIG. 9. Since such a separate guide element 96 is provided for each cavity 95, there are thus six such guide elements 96 in this embodiment. The separate guide elements 96 are separate components, i.e. separate from the holding device 9, which are only pushed into the holding device 9 after the holding device 9 has been manufactured, in order thus to form the cavities 95 for the magnetic field sensors 8. Since the guide elements 96 are separate components, they can be manufactured with very high precision, which is advantageous for the accuracy of the position of the magnetic field sensors 8. In addition, the separate guide elements 96 make it particularly easy to adapt the dimensions of the cavity 95 to the respective magnetic field sensors 8.

As can best be recognized in FIG. 9, each separate guide element 96 has an L-shaped profile. The separate guide element 96 has a bottom 961 (FIG. 10), which forms the short leg of the L, and a side wall 962, which forms the long leg of the L. The bottom 961 of the guide element 96 also forms the bottom of the cavity 95. The side wall 962 of the guide element 96 forms the outside wall 952, which delimits the cavity 95. The side wall 962 comprises two parallel guides 963, between which the magnetic field sensor 8 is pushed when the guide element 96 is inserted into the holding device 9. The two parallel guides 963 have a distance D1 from each other, which corresponds to the corresponding extension of the magnetic field sensor 8, so that the magnetic field sensor 8 can be pushed between the two guides 963 and in the process is guided by the guides 963. The two guides 963 have a length L, which in the inserted state is the extension of the guides 963 in the axial direction. The length L is dimensioned such that it is at least as great as the corresponding dimension of the magnetic field sensor 8, so that the magnetic field sensor 8 does not project beyond the guide element 96 with respect to the axial direction A.

As already mentioned, the holding device 9 in the embodiment described here is designed in such a way that it can receive the circuit board 7 with the magnetic field sensors 8 arranged thereon. For this purpose, the holding device 9 comprises a ring-shaped edge 97 (FIG. 9) with a shoulder 98 provided thereon, wherein the shoulder 98 is arranged radially inwards with respect to the edge 97. The shoulder 98 is designed and arranged in such a way that the circuit board 7 can be placed on the shoulder 98 and rests against this shoulder 98. Optionally, the circuit board 7 can be attached to the shoulder 98 and thus to the holding device 9 by several screws 75. Preferably, the edge 97 is designed in such a way that it projects beyond the circuit board 7 with respect to the axial direction A. This has the advantage that the entire holding device 9 can then be poured with a potting compound and the circuit board is completely covered by the potting compound.

In a sectional representation, FIG. 11 shows the containment can 21 of the stator 2 of the embodiment of the magnetic levitation device, whereby the section is made in the axial direction A.

The containment can 21 with the cup-shaped recess 211 is preferably designed in one piece. The containment can 21 is preferably made of a plastic and in particular preferably of a plastic that can be processed by injection molding. Thus, the containment can 21 is preferably designed as an injection molded part. Suitable plastics for manufacturing the containment can 21 are, for example, acrylonitrile-butadiene-styrene (ABS), polyamide (nylon, PA), polypropylene (PP), polytetrafluoroethylene (PTFE), perfluoroalkoxy alkanes (PFA), polyvinyl chloride (PVC), polybutylene terephthalate (PBT), polyimide (PI), polyether ketone, polysuccinimide (PSI), polyphthalamide (PPA) or polyether ether ketone (PEEK).

The containment can 21 comprises the cup-shaped recess 211, into which the rotor 3 can be inserted, and the radially outer edge 212, which, in the assembled state, embraces the axial edge area 92 of the holding device 9.

In the following, it will be explained how the magnetic levitation device can be assembled in a very simple manner. For example, the assembly can be performed as follows. The circuit board 7 with the magnetic field sensors 8 arranged and attached on it is inserted into the holding device 9. For this purpose, each of the magnetic field sensors 8 is first pushed into one of the cavities 95 and then the circuit board 7 is placed on the shoulder 98 of the holding device 9. Optionally, the circuit board 7 is attached to the holding device 9 by the screws 75.

Subsequently, the holding device 9 is completely poured with a first potting compound in such a way that the circuit board 7 is completely covered by the first potting compound. This first potting compound is preferably a soft potting compound. A soft potting compound refers to a potting compound that has a Shore hardness D of less than 40. For example, silicones or polyurethanes are suitable as the first potting compound. During operation of the magnetic levitation device 1, strong and frequent temperature fluctuations can occur, in particular in the area of the holding device 9 with the magnetic field sensors 8 arranged therein. A soft potting compound is more resistant to such fluctuations. A soft potting compound is therefore preferred for pouring the holding device 9.

The coil cores 25 are passed through the notches 91 in the holding device 9 and through the concentrated windings 61. The magnetic back iron 22 is arranged between the first ends 261 of the longitudinal legs 26. The holding device 9, the back iron 22 and the coil cores 25 with the concentrated windings 61 arranged thereon are inserted into the stator housing 101 of the housing 10 in a first installation direction in axial direction A (according to the representation in FIG. 2 from the left side). In the process, the electrical connecting element 76 is passed parallel to the longitudinal legs 26 of the coil cores 25 through the stator housing 101 into the control housing 102.

When the holding devices 9, the windings 61, the back iron 22 and the coil cores 25 are arranged in the stator housing 101 of the housing 10, the containment can 21 is placed on the housing 10 and connected to the housing 10 in a sealed, preferably hermetically sealed, manner, whereby the seal 201 is arranged between the containment can 21 and the housing 10.

Subsequently, the housing 10 of the magnetic levitation device 1 is poured with a thermally conductive potting compound. Preferably, a second potting compound is used for this, which is thermally well conductive and is different from the first potting compound. The second, thermally conductive potting compound is preferably harder than the first potting compound. The second thermal potting compound should have a particularly good thermal conductivity in order to quickly and reliably dissipate the heat generated in the operating state into the housing, from where the heat is then dissipated mainly by convection. Polyurethanes, epoxy resins, acrylic resins or polyesters, for example, are suitable as the second, thermally conductive potting compound.

After the stator housing 101 of the housing 10 has been poured with the second potting compound, the control unit 40 is inserted into the control housing 102 of the housing 10 in a second installation direction, wherein the second installation direction is opposite to the first installation direction. According to the representation in FIG. 2, the control unit 40 is thus inserted into the control housing 102 from the right. The electrical connecting element 76 is connected to the control unit 40.

When the control unit 40 is arranged in the control housing 102 of the housing 10, the housing cover 11 is placed on the housing 10 and connected to the housing 10 in a sealed, preferably hermetically sealed, manner, wherein the sealing element 105 is arranged between the housing cover 11 and the housing 10. The housing cover 11 is attached to the housing 10, for example by several screws 111 (FIG. 1).

Optionally, the control housing 102 of the housing 10 can also be poured with a potting compound, for example for applications with highly corrosive or aggressive or explosive fluids. If the control housing is also poured, this is done before the housing cover 11 is placed on the housing 10 and is firmly connected to it.

Furthermore, a centrifugal pump 100 for conveying a fluid is proposed by the disclosure, which is characterized in that the centrifugal pump 100 comprises a magnetic levitation device 1 and a rotor 3, wherein the magnetic levitation device 1 is designed according to the disclosure. The magnetic levitation device 1 is designed in such a way that, in addition to the contactless magnetic levitation of the rotor 3, it can generate a torque acting on the rotor 3 which drives its rotation about the axial direction A.

FIG. 12 shows an embodiment of a centrifugal pump according to the disclosure, which is designated in its entirety by the reference sign 100, in a schematic sectional representation in a section in the axial direction A. For better understanding and for reasons of better overview, the housing 10 and the containment can 21 are not represented in FIG. 12.

The centrifugal pump 100 comprises a pump unit 50 with a pump housing 51 comprising an inlet 52 and an outlet 53 for the fluid to be conveyed, wherein the rotor 3 is arranged in the pump housing 51 and comprises a plurality of vanes 54 for conveying the fluid. The pump unit 50 is designed in such a way that the pump unit 50 can be inserted into the containment can 21 the stator 2 such that the magnetically effective core 31 of the rotor 3 is surrounded by the end faces 271 of the transverse legs 27.

It is an advantageous aspect that the rotor 3 is designed as an integral rotor, because it is both the rotor 3 of the magnetic levitation and the rotor 3 of the centrifugal pump 100, with which the fluid is conveyed. This embodiment as an integral rotor offers the advantage of a very compact and space-saving design.

The stator 2 is arranged in the housing 10 (not represented in FIG. 12), which is preferably designed together with the containment can 21 as a hermetically sealed housing 10. The control unit 40 is preferably, but not necessarily, also arranged in the housing 10. The housing 10 is preferably filled with a potting compound, for example with an epoxy resin, an acrylic resin, a polyester, or a polyurethane, so that all components which are arranged inside the housing 10 are surrounded by the potting compound.

The pump unit 50 is arranged in the cup-shaped recess 211 of the containment can 21 (not represented in FIG. 12), so that the rotor 3 provided in the pump housing 51 is surrounded by this cup-shaped recess 211, wherein the magnetically effective core 31 of the rotor 3 is arranged between the transverse legs 27 of the coil cores 26.

The pump housing 51 is fixed to the housing 20, preferably by a plurality of screws (not represented).

The rotor 3 comprises the plurality of vanes 54 for conveying the fluid. For example, in the embodiment described here, a total of four vanes 54 are provided, whereby this number has an exemplary character. The rotor 3 further comprises a jacket 38 with which the magnetically effective core 31 of the rotor 3 is enclosed and preferably hermetically encapsulated so that the magnetically effective core 31 of the rotor 3 does not come into contact with the fluid to be conveyed. All vanes 54 are arranged on the jacket 38 and arranged equidistantly with respect to the circumferential direction of the rotor 3. Each vane 54 extends outward in the radial direction and is connected to the jacket 38 in a torque-proof manner. The vanes 54 can be separate components that are then fixed to the jacket 38. Of course, it is also possible that all vanes 54 are an integral part of the jacket 38, i.e., that the jacket 38 is designed with all the vanes 54 in one piece. The rotor 3 with the vanes 54 forms the wheel or the impeller of the centrifugal pump 100, with which the fluid or fluids are acted upon.

Depending on the application, it is preferred if the pump housing 51 of the pump unit 50 as well as the jacket 38 and the vanes 54 are made of one or more plastics. Suitable plastics are: polyethylene (PE), low density polyethylene (LDPE), ultra-low density polyethylene (ULDPE), ethylene vinyl acetate (EVA), polyethylene terephthalate (PET), polyvinyl chloride (PVC), polypropylene (PP), polyurethane (PU), polyvinylidene fluoride (PVDF), acrylonitrile butadiene styrene (ABS), polyacryl, polycarbonates (PC), polyetheretherketone (PEEK) or Silicones. For many applications, the materials known under the brand name Teflon, polytetrafluoroethylene (PTFE) and perfluoroalkoxy polymers (PFA), are also suitable as plastics.

It is understood that the magnetic levitation device 1 according to the disclosure is also suitable for devices other than centrifugal pumps, for example for mixing devices for mixing flowable substances, for stirring devices, for example for mixing a fluid in a tank, for fans or also for devices for supporting and rotating wafers, for example in semiconductor production.

What is claimed is:

1. A magnetic levitation device for contactless magnetic levitation of a rotor comprising a disk-shaped or ring-shaped magnetically effective core, the magnetic levitation device comprising:
a stator comprising a plurality of coil cores, each of the plurality of coil cores comprising a longitudinal leg extending from a first end in an axial direction to a second end, and a transverse leg arranged at the second end of the longitudinal leg and extending in a radial direction perpendicular to the axial direction, a concentrated winding provided at each longitudinal leg of the plurality of coil cores surrounding a respective longitudinal leg, the stator including a cup-shaped recess into which the rotor is configured to be inserted, the cup-shaped recess arranged at an axial end of the stator, each of the transverse legs of the plurality of coil cores arranged around the cup-shaped recess; and
a plurality of magnetic field sensors configured to determine the position of the rotor arranged around the cup-shaped recess; and
a ring-shaped holding device for the magnetic field sensors, the ring-shaped holding device having a cavity for each magnetic field sensor of the plurality of magnetic field sensors, the cavity delimited with respect to the radial direction by an inside wall and by an outside wall, the magnetic field sensors configured to be pushed into the cavity, and the cavity dimensioned such that the inside wall and the outside wall rest flat against the magnetic field sensors.

2. The magnetic levitation device according to claim 1, further comprising a circuit board arranged between the concentrated windings and the transverse legs of the plurality of coil cores with respect to the axial direction, all of the magnetic field sensors being arranged on the circuit board, and the holding device configured to receive the circuit board.

3. The magnetic levitation device according to claim 2, wherein the holding device has a ring-shaped edge with a shoulder provided thereon, the shoulder arranged radially inwardly with respect to the edge, and the circuit board rests against the shoulder.

4. The magnetic levitation device according to claim 3, wherein the edge is configured so as to project beyond the circuit board with respect to the axial direction.

5. The magnetic levitation device according to claim 1, wherein the holding device has a plurality of notches, such that for each coil core of the plurality of coils cores, a notch of the plurality of notches encloses a respective coil core of the plurality of coil cores and receives the transverse leg of the respective coil core.

6. The magnetic levitation device according to claim 5, wherein each cavity is arranged between two adjacent notches of the plurality of notches with respect to the circumferential direction.

7. The magnetic levitation device according to claim 1, wherein the plurality of coil cores includes exactly six coil cores.

8. The magnetic levitation device according to claim 1, wherein the plurality of magnetic field sensors comprises exactly six magnetic field sensors arranged equidistantly around the cup-shaped recess.

9. The magnetic levitation device according to claim 2, wherein the holding device is filled with a first potting compound such that the circuit board is completely covered by the potting compound.

10. The magnetic levitation device according to claim 1, wherein a guide element is provided in for each cavity, and forms the inside wall or the outside wall delimiting the cavity.

11. The magnetic levitation device according to claim 1, wherein the stator has a containment can forming an axial end of the stator, the containment can include the cup-shaped recess into which the rotor is configured to be inserted and the containment can is configured to embrace the holding device radially outwardly.

12. The magnetic levitation device according to claim 1, further comprising a housing comprising a stator housing and a control housing arranged adjacent to each other with respect to the axial direction, the stator housing configured to receive the plurality of coil cores with the concentrated windings arranged thereon, and the control housing configured to receive a controller configured to control and supply the concentrated windings with electrical energy to generate electromagnetic fields.

13. The magnetic levitation device according to claim 12, wherein the housing configured to such that the plurality coil cores with the concentrated windings arranged thereon are configured to be inserted into the stator housing in a first installation direction in the axial direction, and the controller is configured to be inserted into the control housing in a second installation direction, the first installation direction is directed in an opposite direction to the second installation direction.

14. The magnetic levitation device according to claim 1, wherein the stator is configured to generate a torque with which the rotor is capable of being driven magnetically without contact for rotation about the axial direction.

15. A centrifugal pump for conveying a fluid, comprising:
the magnetic levitation device according to claim 14; and
the rotor with the magnetically effective core, the rotor configured to be inserted into the cup-shaped recess of a containment can.
